(19) United States
(12) Patent Application Publication
(10) Pub. No.: US 2024/0242298 A1
(43) Pub. Date: Jul. 18, 2024

(54) Decentralised Travel Identity Management System and Related Methods

(71) Applicant: Gurpreet Singh Mann, Slough (GB)

(72) Inventor: Gurpreet Singh Mann, Slough (GB)

(21) Appl. No.: 18/096,094

(22) Filed: Jan. 12, 2023

(51) Int. Cl. G06Q 50/14; G06F 16/182; G06F 21/32; G06Q 10/02

(52) U.S. Cl. CPC G06Q 50/14; G06F 16/1824; G06F 21/32; G06Q 10/02

(57) ABSTRACT

The present disclosure provides a decentralised system for travel identity management. The system is comprised of a number of user devices in communication with a set of nodes managing a distributed ledger database. The nodes are configured to, upon receipt of a set of verified identity documents, generate a universal user travel profile, populate it with user data and travel preferences, and write it to the distributed database. This facilitates quick and convenient provision of verified user data to a number of third parties throughout the complex modern travel industry.

### FIELD OF INVENTION

The present invention relates generally to identity management systems. More specifically, the present invention relates to a system comprising a distributed ledger database that stores verified travel profiles for a number of users, providing interoperable access to third parties.

### BACKGROUND

The travel industry is, by nature, a highly complex and interlinked system where a user must interact with a large number of separately managed third parties in order to achieve their goals. Booking agencies, transport agencies, accommodation providers and insurance agencies are just a small selection of examples of third parties that a user must correspond with separately while planning their travels. The system becomes even more complex when the travel is for work purposes, and employers must be consulted at various steps. In order to correspond with each of these parties, a user must share their personal data with each one individually, and often there is a verification process involved for each one too, to confirm the user's identity.

Identity management is a challenging task, even more so when it involves multiple parties that do not trust each other and therefore do not share their databases, as is the case in the travel industry.

The lack of efficiency that results from identity verification needing to be performed separately with each third party not only costs time and money, it also leads to increased security risks for the shared data because each organization is at risk of data leaks.

The problems with this system are not limited to the users who must repeatedly confirm their identities. At an organizational level, the time and cost of repeated identity checks is high, and the potential of human errors leading to database inconsistencies is increased. The data recorded by different organizations will also most likely have some divergence, and this lack of synchronicity can lead to organizations failing to detect potential bad actors.

In recent years, several blockchain-based identity management solutions have been proposed. A blockchain is a computer-implemented decentralized, consensus-based, distributed system made up of blocks which in turn are made up of transactions. Each block contains a hash of the data contained in the previous block which acts as a digital fingerprint so that the blocks become chained together to create a permanent, immutable record of all data which have been written to the blockchain since its inception. The data written to these distributed ledger can be associated with different addresses on the blockchain in question, each of which are denoted by their own unique string of characters or ID. This is often in the form of a full cryptographic hash that is the public counterpart of an asymmetric private-public encryption key pair.

The ability to immutably record sets of verified data on a distributed ledger has the ability to solve the above-mentioned problems for identity management, and has particular applications in the travel industry where so many different untrusted parties must cooperate to verify the same dataset. Furthermore, once an immutable and verified travel profile has been created for a user, various travel related insights and opportunities for interoperability between third parties can be unlocked, which is an area that has not been explored by the more general identity management solutions proposed in the art.

It is within this context that the present invention is provided.

### SUMMARY

The present disclosure provides a decentralised system for travel identity management. The system is comprised of a number of user devices in communication with a set of nodes managing a distributed ledger database. The nodes are configured to, upon receipt of a set of verified identity documents, generate a universal user travel profile, populate it with user data and travel preferences, and write the data to the distributed database. This facilitates quick and convenient provision of verified user data to a number of third parties throughout the complex modern travel industry.

Thus, according to one aspect of the present disclosure there is provided a system for managing one or more travel identities, the system comprising: one or more user devices; and a plurality of networked nodes in communication with the one or more user devices, each node having stored thereon a copy of a distributed ledger database.

The plurality of nodes are each configured to: receive a request from a user device to create a travel profile for a user, the request comprising one or more authenticating documents containing personal data for the travel profile; verifying the authenticating documents via a third party; upon verification of the authenticating documents by the third party, generate a travel profile for the user and populating the travel profile with the personal data from the authenticating documents; receiving, from the user device, one or more travel preference selections for the user and adding the selections to the user travel profile; write the user travel profile to the distributed ledger database and generate a unique ID associated with the user travel profile; receive requests for user data in the travel profile from one or more third parties, the requests containing the unique ID, and grant the one or more third parties access to at least a portion of the user data in the travel profile based on the request.

In some embodiments, the distributed ledger database is a blockchain, and the step of writing the user travel profile to the distributed ledger database comprises generating a new block containing the travel profile and associated personal data and travel preferences and adding the block to the copy of the blockchain stored on each node in the system.

In some embodiments, the nodes are each further configured to receive a request to update a user travel profile associated with a unique ID with new travel-relevant data, verify that the requesting user device has permission to edit the associated travel profile, and write the updated profile data to the distributed ledger database.

In some embodiments, the data on the distributed ledger associated with a travel profile is viewable on-demand on a dashboard interface for verified user devices.

In some embodiments, user devices are verified by one or more of: biometric security protocols, public-private key protocols, and private pin and passkeys.

In some embodiments, the one or more nodes comprise a set of servers operating via a cloud-based web architecture in addition to managing the distributed ledger database.

In some embodiments, the nodes are further configured to receive a request to update the travel profile with enterprise data for the user, the request containing the unique ID associated with the user travel profile.

In some embodiments, the one or more third parties include one or more of: booking agencies, transportation agencies, security agencies, accommodation agencies, employment agencies, and passport controllers.

In some embodiments, each node is configured to update the user travel profile in response to each request from a third party, and write the record of the request and updated profile to the distributed ledger database.

In some embodiments, one or more of the nodes are also personal user devices configured to store a copy of the user travel profile such that it is accessible in an offline state.

In some embodiments, the nodes are further configured to monitor the data stored on a user travel profile and the interactions with third parties to maintain a travel itinerary associated with the travel profile. The nodes may be further configured to monitor travel relevant information and notify a user device associated with the travel profile with travel-relevant updates and recommendations, and the travel relevant updates and recommendations may include one or more of: alerts for potential travel delays, opportunities for travel-related purchases, and alternative booking options.

In some embodiments, the unique ID is provided in the form of a unique visual code that provides access to the verified travel profile of a user when it is scanned. The unique ID may thereby act as a single sign-on code for the user.

### BRIEF DESCRIPTION OF THE DRAWINGS

Various embodiments of the invention are disclosed in the following detailed description and accompanying drawings.

FIG. 1 illustrates an example network architecture for implementing the disclosed system.

FIG. 2 illustrates an example set of steps carried out by the nodes of the distributed network of the example architecture.

FIG. 3A-FIG. 3F illustrate various example user interface screens of a user device accessing the disclosed system.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

One or more of the operations and calculations described herein may be performed by a cloud infrastructure comprising one or more servers and databases. This is merely an example infrastructure however, the servers need not necessarily be cloud-based. The cloud infrastructure may for example comprise a database configured to receive and store multimedia content and user data for a plurality of user accounts and a set of connected servers or nodes configured to enact the operations as disclosed herein.

Any one of the client devices may be operationally coupled to a wide area network (WAN) such as the Internet with a wireless connection. The wireless clients may be communicatively coupled to the WAN via a Wi-Fi (or Bluetooth) access point that is communicatively coupled to a modem, which is communicatively coupled to the WAN. The wireless clients may also be communicatively coupled to the WAN using a proprietary carrier network that includes communication tower.

Furthermore, both the client devices and servers or a combination thereof may be part of a network of nodes forming a distributed ledger database network such as a blockchain.

The term “blockchain” may be understood, in particular in the claims, preferably in the description as a distributed database maintaining a continuously growing list of data records that are hardened against tampering and revision even by operators of the data storing nodes hosting database. A blockchain comprises for example two kinds of records: so-called transactions and so-called blocks. Transactions may be the actual data to be stored in the blockchain and blocks may be records confirming when and in what sequence certain transactions became journaled as a part of the blockchain database. Transactions may be created by participants and blocks may be created by users who may use specialized software or equipment designed specifically to create blocks.

While a specific set of client devices are listed as examples of the architecture, the client devices may in fact be any suitable device. For example, client devices could include a mobile handset, mobile phone, wireless phone, portable cell phone, cellular phone, portable phone, a personal digital assistant (PDA), a tablet, a portable media device, a wearable computer, or any type of mobile terminal which is regularly carried by an end user and has all the elements necessary for operation in a wireless communication system. The wireless communications include, by way of example and not of limitation, CDMA, WCDMA, GSM, UMTS, or any other wireless communication system such as wireless local area network (WLAN), Wi-Fi or WiMAX.

In some examples, each client device may be associated with or “logged in” to a user profile in order to operate within the disclosed system and method, and further configured to send requests, upload user data, and generally interact with the cloud infrastructure via a user interface displayed on the device.

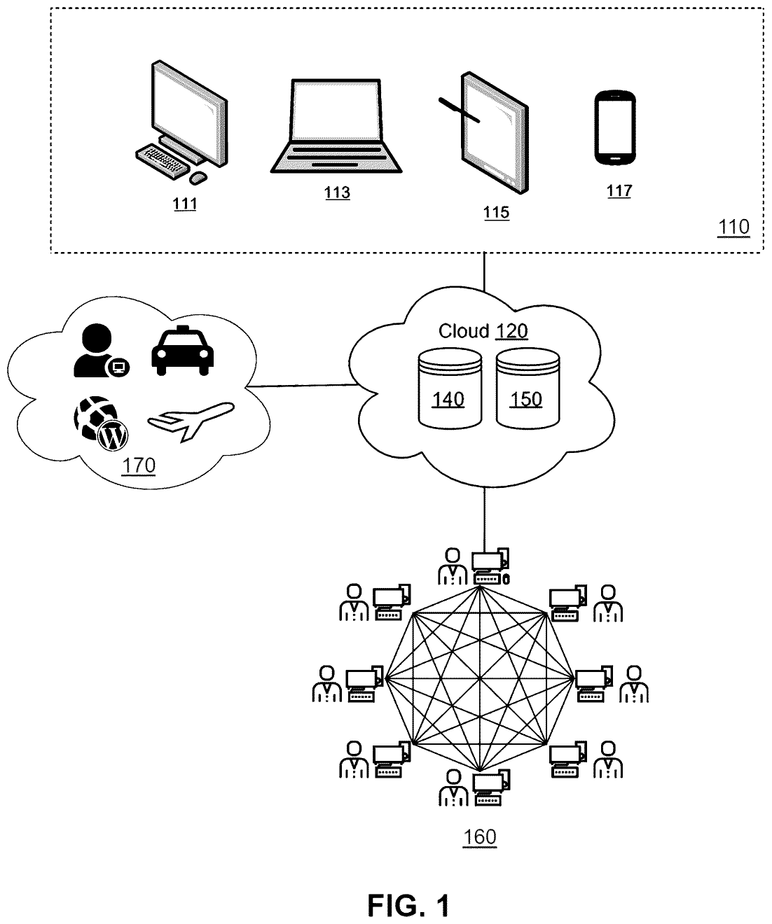

Referring to FIG. 1, an example system architecture for implementing the operations disclosed herein is shown.

The architecture includes a set of user devices 110, a cloud network architecture 120 with a database 140 and server 150, and a blockchain network 160. The cloud 120 interfaces with a set of third party service providers 170.

Exemplary user devices 110 as may be used in the Identity Management System include, without limitation, a personal computer (PC) 111, a laptop 113, a tablet computer 115, and smartphone 117. Generally, each user device 119 includes a display and/or one or more processors. The display 115 offers the user a visual interface for interaction with the Identity Management System. For example, the Identity Management System may be presented in a dedicated application or “App” platform with a custom interface that makes use of known techniques for user interaction. The platform may also be accessed via a standard web browser in some examples.

Generally, each user device 110 is in communication with cloud network 120 through a communications channel. The cloud network 120 is also in communication with server 140 and may further communicate with a database 150.

The server 140 contains instruction sets governing platform operations. The database 150 contains data on the users of the system and any other information acquired by interfacing with third parties 170 through Applications Programming Interfaces. The database 150 may also contain user account information, history, etc. The foregoing are merely illustrative of the architecture of the Performance Monitoring System and is not meant to be limiting.

The networked nodes of the blockchain 170 are in communication with the one or more user devices 110 and the third parties 170 via the cloud 120.

Each node in the network has stored thereon a copy of a distributed ledger-type database which records verified identity data submitted through authorised user devices and third parties in an immutable record that can be accessed to authenticate the identity of users for travel purposes and act as a universal travel pass.

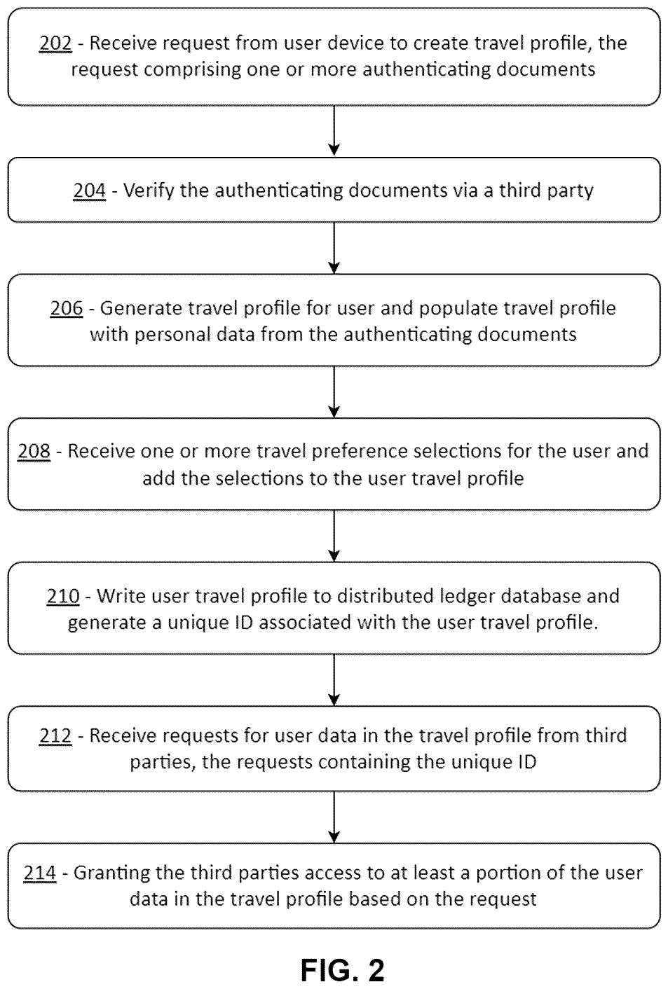

Referring to FIG. 2, an example set of steps carried out by the nodes of the distributed network of the example architecture is shown.

In a first step 202 the node receives a request from a user device to create a travel profile. The request contains one or more authenticating documents containing personal data for the travel profile. For example, a scan of a passport may be uploaded from the user device. The user device may need to be authenticated itself to access and interface with the system—for example a user may need to create and verify a profile on the system and protect their device with biometric security protocols, public-private key protocols, or simply a private pin/passkey.

In a second step 204, the node verifies the authenticating documents via a third party. This may involve checking the details contained in the document with an authorised entity such as a passport issuer.

In a third step 206, upon verification of the authenticating documents, the node generates a travel profile for the user and populates the travel profile with the personal data from the authenticating documents—i.e. name, date of birth, nationality, passport number, etc. At this point the user may also have an opportunity to input preferences and additional information into their travel profile.

Thus in a fourth step 208, the node receives one or more travel preference selections for the user and adds the selections to the user travel profile. Together with the personal data from the authenticated documents, the initial information for the travel profile is now complete and should contain sufficient information to allow for automated answering of most travel related queries.

In a fifth step 210, the node then writes the user travel profile to the distributed ledger database and generates a unique ID associated with the user travel profile. The process for this can vary between different types of distributed ledger technology, but in general this involves generating a new block containing the travel profile and associated personal data and travel preferences and adding the block to the copy of the blockchain stored on the node, then sending the updated blockchain to each node in the system. The unique ID may be a public key of a cryptographic key pair for accessing the data of the travel profile on the blockchain, and may be represented in the form of a scannable QR code.

The verified information of the travel profile is thus immutably recorded on the blockchain, and becomes accessible to any entities wishing to verify the data and which are given access to the unique ID. In practice, this means that a user can simply scan a QR code from their device to provide requesting entities with confirmation that they are who they say they are, while simultaneously sharing all travel relevant information. This can include medical information such as allergies, heart conditions, etc.

This has the secondary effect of allowing the travel profile to act as a single-sign on for all travel services the user utilises, similar to the now common “Log in with Google” function available on many websites.

In a sixth step 212, the node receives requests for user data in the travel profile from one or more third parties. This happens when the unique ID is shared with a third party such as a booking agency, transportation agency, security agency, accommodation agency, employment agency, or passport controllers—either via the a QR code scan or wireless transmission from the user device associated with the travel profile—allowing the interested third party to make a request to the blockchain to view a portion of the verified data.

In a seventh step 214, the node grants the requesting party access to the data in the travel profile based on the request. The system may be designed such that only data which is relevant to the requesting party is made available. Various permission/authorisation levels of requesting entities may be tracked in a database to determine what information is shown to requesting entities.

Furthermore, the system may track such requests and the node may be configured to update the user travel profile in response to each request from a third party, writing the record of the request and the updated profile to the blockchain. The history of interaction of a travel profile with various third entities may thus be immutably recorded.

The information in the travel profile should be viewable to the user via a dashboard on their client device. A user can also update the information in their own travel profile through the dashboard by verifying their identity with the client device (i.e. logging on with two factor or biometric authentication) and inputting changes or new information, which is then sent in a request received by the nodes and written to the blockchain.

A copy of the travel profile information is usually stored on the user's device so that it can be viewed, accessed, and shared even in an offline state.

Enterprises such as employers may also able to add information to a user's travel profile if they have appropriate permissions within the system and make requests using the unique ID associated with the user's travel profile.

The disclosed methods provide a universal travel profile that contains verified identity details and travel-related information for a user, which can be continuously updated with new information such as purchases, interactions with travel companies, etc. The universal nature of the travel profile—i.e. the ability of any third party with a unique ID to access relevant portions of its data—allows interoperability between various third party systems that a user utilises.

The availability of verified, up-to-date travel data for a user also facilitates smart functions such as the automated generation of dynamic itineraries where users can be notified of potential disruptions or risks associated with their travel plans. The insights can also be used to intelligently suggest upselling opportunities and recommended purchases to users, such as the possibility to upgrade to premium classes during a flight that the travel profile has been booked onto.

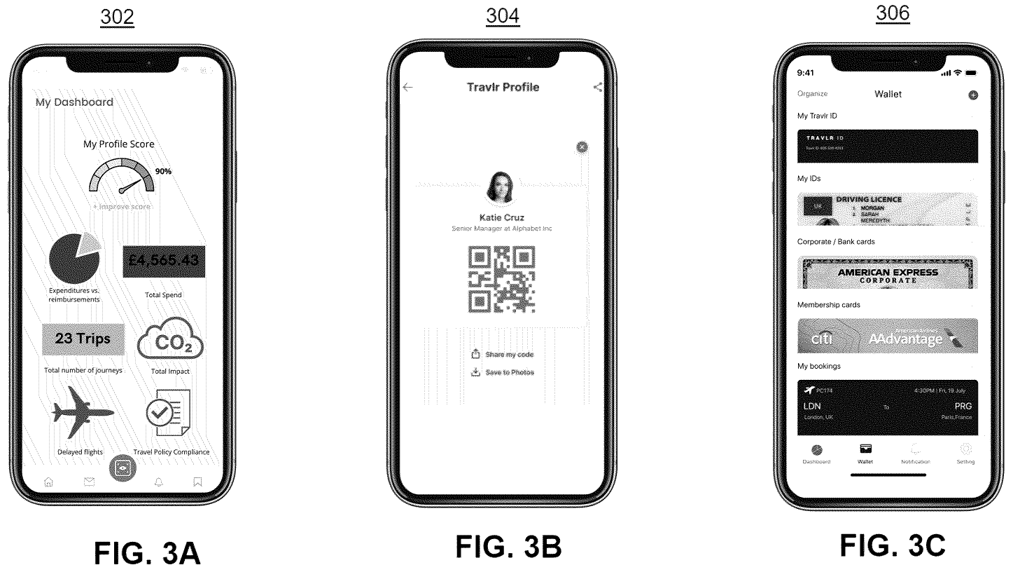

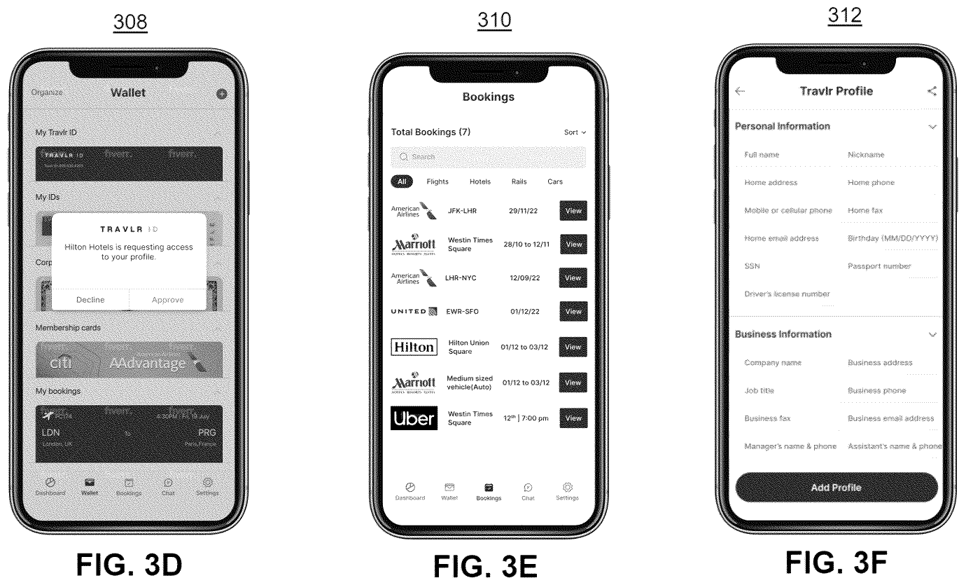

FIG. 3A-FIG. 3F show various example user interface screens of a user device with an app for accessing the disclosed system.

FIG. 3A shows a user dashboard 302 where a user can view all travel relevant information for their current and past trips.

FIG. 3B shows an example QR code share screen 304 for sharing a unique ID associated with a user profile.

FIG. 3C shows a wallet page 306 of the dashboard where a user can manage various payment information, bookings, and authentication documents.

FIG. 3D shows a new notification 308 for a user where a third party is requesting access to the user details on their travel profile for the purposes of accommodation. A user can grant access or refuse the request.

FIG. 3E shows a booking page 310 on the app where a user may view and manage the details of their bookings with various service providers.

FIG. 3F shows a profile page 312 of the app where a user can add or change the data of their travel profile.

The various operations that a user can perform through the interfaces of FIG. 3A-3F may each be coordinated with the nodes of the distributed ledger network as described above.

The operations described above for the app may also be implemented by one or more servers or computers over a wireless network which the user device are communicating through. Indeed, it should be understood that the operations described herein may be carried out by any suitable processor architecture.

In particular, the operations may be carried out by, but are not limited to, one or more computing environments used to implement the method such as a data center, a cloud computing environment, a dedicated hosting environment, and/or one or more other computing environments in which one or more assets used by the method re implemented; one or more computing systems or computing entities used to implement the method; one or more virtual assets used to implement the method; one or more supervisory or control systems, such as hypervisors, or other monitoring and management systems, used to monitor and control assets and/or components; one or more communications channels for sending and receiving data used to implement the method; one or more access control systems for limiting access to various components, such as firewalls and gateways; one or more traffic and/or routing systems used to direct, control, and/or buffer, data traffic to components, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the method; one or more databases used to store data; one or more internal or external services used to implement the method; one or more backend systems, such as backend servers or other hardware used to process data and implement the method; one or more software systems used to implement the method; and/or any other assets/components in which the method is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

Unless specifically stated otherwise, as would be apparent from the above discussion, it is appreciated that throughout the above description, discussions utilizing terms such as, but not limited to, “activating”, “accessing”, “adding”, “applying”, “analyzing”, “associating”, “calculating”, “capturing”, “classifying”, “comparing”, “creating”, “defining”, “detecting”, “determining”, “eliminating”, “extracting”, “forwarding”, “generating”, “identifying”, “implementing”, “obtaining”, “processing”, “providing”, “receiving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system for reviewing service provider experiences with clients have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for managing one or more travel identities, the system comprising:
one or more user devices; and
a plurality of networked nodes in communication with the one or more user devices, each node having stored thereon a copy of a distributed ledger database, the plurality of nodes each being configured to:
receive a request from a user device to create a travel profile for a user, the request comprising one or more authenticating documents containing personal data for the travel profile;
verifying the authenticating documents via a third party;
upon verification of the authenticating documents by the third party, generating a travel profile for the user and populating the travel profile with the personal data from the authenticating documents;
receiving, from the user device, one or more travel preference selections for the user and adding the selections to the user travel profile;
writing the user travel profile to the distributed ledger database and generating a unique ID associated with the user travel profile;
receiving requests for user data in the travel profile from one or more third parties, the requests containing the unique ID, and granting the one or more third parties access to at least a portion of the user data in the travel profile based on the request.

2. A system for managing one or more travel identities according to claim 1, wherein the distributed ledger database is a blockchain, and the step of writing the user travel profile to the distributed ledger database comprises generating a new block containing the travel profile and associated personal data and travel preferences and adding the block to the copy of the blockchain stored on each node in the system.

3. A system for managing one or more travel identities according to claim 1, wherein the nodes are each further configured to receive a request to update a user travel profile associated with a unique ID with new travel-relevant data, verify that the requesting user device has permission to edit the associated travel profile, and write the updated profile data to the distributed ledger database.

4. A system for managing one or more travel identities according to claim 1, wherein the data on the distributed ledger associated with a travel profile is viewable on-demand on a dashboard interface for verified user devices.

5. A system for managing one or more travel identities according to claim 1, wherein user devices are verified by one or more of: biometric security protocols, public-private key protocols, and private pin and passkeys.

6. A system for managing one or more travel identities according to claim 1, wherein the one or more nodes comprise a set of servers operating via a cloud-based web architecture in addition to managing the distributed ledger database.

7. A system for managing one or more travel identities according to claim 1, wherein the nodes are further configured to receive a request to update the travel profile with enterprise data for the user, the request containing the unique ID associated with the user travel profile.

8. A system for managing one or more travel identities according to claim 1, wherein the one or more third parties include one or more of: booking agencies, transportation agencies, security agencies, accommodation agencies, employment agencies, and passport controllers.

9. A system for managing one or more travel identities according to claim 1, wherein each node is configured to update the user travel profile in response to each request from a third party, and write the record of the request and updated profile to the distributed ledger database.

10. A system for managing one or more travel identities according to claim 1, wherein one or more of the nodes are also personal user devices configured to store a copy of the user travel profile such that it is accessible in an offline state.

11. A system for managing one or more travel identities according to claim 1, wherein the nodes are further configured to monitor the data stored on a user travel profile and the interactions with third parties to maintain a travel itinerary associated with the travel profile.

12. A system for managing one or more travel identities according to claim 11, wherein the nodes are further configured to monitor travel relevant information and notify a user device associated with the travel profile with travel-relevant updates and recommendations.

13. A system for managing one or more travel identities according to claim 12, wherein the travel relevant updates and recommendations include one or more of: alerts for potential travel delays, opportunities for travel-related purchases, and alternative booking options.

14. A system for managing one or more travel identities according to claim 1, wherein the unique ID is provided in the form of a unique visual code that provides access to the verified travel profile of a user when it is scanned.

15. A system for managing one or more travel identities according to claim 14, wherein the unique ID thereby acts as a single sign-on code for the user.
